(19) United States
(12) Patent Application Publication
(10) Pub. No.: US 2025/0033007 A1
(43) Pub. Date: Jan. 30, 2025

(54) AIR HUMIDIFIER, METHOD FOR OPERATING AN AIR HUMIDIFIER, AND SYSTEM HAVING AT LEAST ONE AIR HUMIDIFIER

(71) Applicant: MTU Aero Engines AG, Muenchen (DE)

(72) Inventor: Jan HÄGERT, Alling (DE)

(21) Appl. No.: 18/559,974

(22) PCT Filed: May 2, 2022
(86) PCT No.: PCT/DE2022/100332

§ 371 Date: Nov. 9, 2023

(30) Foreign Application Priority Data
May 12, 2021 (DE) 10 2021 112 492.1

(51) Int. Cl. B01F 25/313; B01F 23/213; B01F 25/10; B01F 35/00; B01F 35/221; B01F 101/55; H01M 8/04119

(52) U.S. Cl. CPC B01F 25/3131; B01F 23/21321; B01F 25/103; B01F 35/2211; B01F 35/55; H01M 8/04126; B01F 2101/55; H01M 2250/20

(57) ABSTRACT

The invention relates to an air humidifier (1) having a mixing chamber (5) in which is disposed an atomizing nozzle (9) configured to discharge a liquid (25) as a spray mist (10). The mixing chamber (5) is configured such that a gas (26) conveyed along a main flow path (8) through the mixing chamber (5) is mixed with the spray mist (10) and discharged at an outlet opening (7) of the mixing chamber (5). The atomizing nozzle (9) has a swirl device configured to impart a swirl to droplets (11) of the spray mist (10) in order to emit the spray mist (10) as a straight circular spray cone (12). It is provided that the mixing chamber (5) has a separating device (16) configured to catch droplets (11) of the circular spray cone (12) that move from the atomizing nozzle (9) along a hollow cone (14) having a predetermined interior angle (15), and to supply droplets (11) that move inside the hollow cone (14) to the outlet opening (7) of the mixing chamber (5).

The present invention relates to an air, a method for operating an air humidifier, and a system.

### BACKGROUND

Some devices require to be supplied with air having a predetermined humidity. Passive and active air humidifier systems are used to provide air, or an air stream, with the required humidity. This is required, for example, for fuel cells having a polymer electrolyte membrane (PEM). Individual fuel cells may be arranged as segments in so-called fuel cell stacks. The individual fuel cell segments have respective polymer electrolyte membranes. In order to enable efficient operation of the fuel cells, it is necessary to humidify the polymer electrolyte membranes by means of supplied cathode air in which water droplets were evaporated. The evaporation in the stack contributes to cooling. On the other hand, it is necessary to prevent the droplets in the cathode air from causing water accumulation in a flow profile, called flow field, of fuel cells. A side effect of the humidification is that the fuel cells are cooled by evaporation of the moisture in the fuel cells. In order to both avoid water accumulation in the fuel cell and to allow cooling of the fuel cells by the droplets, the droplets must not exceed a certain size. In order to provide such small droplets, two-fluid atomizing nozzles are commonly used in the humidifiers.

### SUMMARY OF THE INVENTION

However, in the field of aviation, especially in the field of prime movers, the known solutions and approaches for humidifying fuel cells cannot be implemented or have considerable disadvantages. The passive humidifiers known from the automotive field do not allow for targeted control of the relative humidity of the cathode air. In addition, they are too heavy and too voluminous for use in the field of aviation. In addition, they do not contribute to the cooling of the fuel cell stack. To operate a two-fluid atomizing nozzle commonly used for providing fine droplets, compressed air must be provided at a pressure level significantly above the pressure level of the cathode air itself in order to enable atomization of the water required for humidification. The complexity is increased by the fact that, in the field of aviation, the prevailing atmospheric pressure is low. In addition, in the field of aviation, the ambient air to be humidified is significantly drier, and the amounts of air to be humidified are larger.

Another field of application for air humidifiers in aviation are aircraft turbine engines which are operated as a so-called “water-enhanced turbofan” (WET). In such engines, humidified air is supplied from a water recovery device into a combustion chamber of a turbine engine in order, among other things, to enable a more uniform temperature distribution during combustion in the combustion chamber. This makes it possible to reduce the formation of nitrogen oxides.

U.S. Pat. No. 9,385,380 B2 discloses a method and a system for humidification management in fuel cells. The method provides for supplying air to a cathode inlet stream of a fuel cell. Provision is made for detecting a fuel cell parameter associated with the humidity of the cathode inlet stream. Provision is made for selectively operating the fuel cell in either an active humidification mode or a deactive humidification mode based on the fuel cell parameter. In the active humidification mode, water is added to the cathode inlet stream. In the deactivate humidification mode, no water is added to the cathode inlet stream.

U.S. Pat. No. 5,432,020 A describes a device for providing conditioned process gas for the operation of air-breathing fuel cell systems. To operate the fuel cell systems, a process gas with a predetermined temperature and humidity must be provided. For this purpose, a metered quantity of fine water droplets is injected into the gas supply line, whereby the process air is humidified.

In CN 206163612 U, there is disclosed a humidification device for a proton exchange membrane of a fuel cell.

CN 111640968 A discloses a combination humidifier and a humidification system for fuel cells. The invention includes a membrane humidifier and a combination humidifier. The humidification system is configured to output a gas in a saturated state at an outlet of the humidification system.

U.S. Pat. No. 6,835,477 B1 discloses a fuel cell stack of polymer membrane fuel cells where the removal of the heat generated by the production of electric energy and the humidification of the ion exchange membranes used as electrolytes are obtained by the direct injection of a water flow coming from a single hydraulic circuit.

US20140048615 A1 discloses a two-fluid nozzle for atomizing fluids, which has a nozzle housing. The nozzle housing has at least one fluid inlet for a fluid to be atomized, a second fluid inlet for a gaseous fluid, a mixing chamber, a nozzle outlet opening, and an annular slot opening surrounding the nozzle outlet opening. Within the nozzle housing, a device is provided for generating a film of fluid that is to be atomized on a wall of the mixing chamber, and inlet openings are provided for injecting the gaseous fluid into the mixing chamber.

U.S. Pat. No. 8,028,934 B2 discloses a two-fluid atomizing nozzle configured for spraying a liquid with the aid of a compressed gas. The two-fluid atomizing nozzle includes a mixing chamber into which open a liquid inlet and a compressed gas inlet. The two-fluid atomizing nozzle includes an outlet located downstream of the mixing chamber. Through additional annular slot atomization, a much finer drop spectrum can be produced with the same expenditure of energy. In addition, the two-fluid atomizing nozzle is designed to reduce the average drop size by swirling the central jet.

JP 4718811 B2 discloses a method for converting a liquid into fine particles and a nozzle used in the method. The method provides for a jet flow obtained to be focused onto a collision point in order to atomize droplets at the collision point. The atomized droplets are then sprayed in a circular shape.

CN 110237953 B discloses an environment-friendly atomizing device with a nozzle. The atomization device is configured to subject a three-phase mixed liquid to repeated mixing and collision, whereby a liquid to be sprayed can be atomized more evenly and has finer and smaller droplets.

It is an object of the invention to provide an air humidifier that enables reliable and improved humidification of an air stream with fine liquid droplets, in particular in the field of prime movers in aviation engineering.

A first aspect of the invention relates to an air humidifier having a mixing chamber in which is disposed an atomizing nozzle configured to discharge a liquid as a spray mist. In other words, the air humidifier has the mixing chamber that has an atomizing nozzle for atomizing the liquid. The mixing chamber may be designed to provide a volume for mixing a gas with a liquid. In order to enable mixing of the gas with the liquid, provision is made for the atomizing nozzle to atomize the liquid so that the liquid is discharged as droplets forming a spray mist. The atomizing nozzle is a single-fluid atomizing nozzle. The mixing chamber is configured such that a gas conveyed along a main flow path through the mixing chamber is mixed with the spray mist and discharged at an outlet opening of the mixing chamber. In other words, it is provided that the mixing chamber be configured to convey the gas to be mixed along the main flow path and, after mixing the gas with the liquid, to discharge it at the outlet opening of the mixing chamber. The gas conveyed through the mixing chamber mixes therein with the spray mist, so that the gas discharged from the outlet opening is mixed with the liquid.

For certain applications, it may be necessary that the mixed gas contain only fine droplets. In other words, it may be necessary that the droplets contained in the discharged gas not exceed a certain size. Droplets emitted by atomizing nozzles may differ in size, so that the spray mist may contain finer and coarser droplets. It may therefore be necessary to separate the coarser droplets so that only the finer droplets are emitted. In order to achieve this, it is provided for the atomizing nozzle to have a swirl device configured to impart a swirl to droplets of the spray mist in order to emit the spray mist as a straight circular spray cone opening along the main flow path with a cone angle. In other words, the atomizing nozzle has the swirl device. The swirl device is configured to discharge the spray mist in such a way that an angular momentum is imparted to the droplets of the spray mist. This can be enabled, for example, by discharging the droplets in a spiral shape. Due to the imparted angular momentum and the movement of the droplets along the main flow path of the gas, the individual droplets move along widening spiral paths, starting from the atomizing nozzle. The swirl imparted to the droplets causes the individual droplets to be deflected outward to different extents depending on their size. Due to the spiral paths of the respective droplets, the spray mist composed of the droplets has the shape of an opening straight circular spray cone. The circular spray cone has the cone angle, larger droplets moving in an outer region of the circular spray cone and smaller ones in an inner region of the circular spray cone. By producing the described circular spray cone, the size spectrum of the droplets is distributed with the size increasing from inside to outside. This can provide a basis for separating the droplets as a function of their size.

In order to accomplish the separation, provision is made for the mixing chamber to have a separating device configured to catch droplets of the circular spray cone that move from the atomizing nozzle along a hollow cone having a predetermined interior angle. In other words, provision is made for the separating device to be configured to catch the droplets in the outer region of the circular spray cone. As a result, larger ones of the droplets are separated by the separating device. Due to the size distribution described, the larger ones of the droplets move along the hollow cone emanating from the atomizing nozzle. The hollow cone has the predetermined interior angle that separates the droplets to be separated from the droplets to be passed on. The separating device is configured to collect the caught droplets and to discharge the liquid recovered by catching the droplets at a separation outlet of the separating device. Droplets that move inside the hollow cone are supplied by the separating device to the outlet opening of the mixing chamber. The use of the separating device results in the advantage that the gas discharged from the outlet opening of the mixing chamber contains only the finer droplets, because the coarser droplets have been filtered out. The advantage of the invention is, in particular, that it allows air to be humidified with fine droplets without having to use a two-fluid nozzle. The disadvantage associated with the use of the single-fluid nozzle, namely that no additional, variable control parameter is available and that one may therefore have to accept that larger droplets are also released into the gas, is compensated for by the fact that the larger droplets are filtered out of the gas by the separating device.

The invention also includes optional refinements which provide further advantages.

One refinement of the invention provides that the separating device has a coaxial tube. In other words, the separating device includes the coaxial tube that has an outer tube having an inner tube therein. The outer tube of the coaxial tube is designed to catch the larger ones of the droplets, which move along the hollow cone. The inner tube is designed to convey the finer droplets, which move inside the hollow cone, to the outlet opening of the mixing chamber. The coaxial tube may be centered with respect to the atomizing nozzle, so that the circular spray cone is aligned along the main flow path with the coaxial tube. A base area of a cone having the interior angle may correspond to an opening of the inner tube. The finer droplets are thus guided from the atomizing nozzle along the main flow path into the inner tube through which they are supplied to the outlet opening. An annular base area of the hollow circular cone may coincide with an entrance area of the outer tube, so that the coarser droplets are guided into the outer tube. As a result, these droplets are not supplied to the outlet opening.

A refinement of the invention provides that the separating device has a separating opening circumferentially surrounded by a baffle, the baffle being configured to catch the droplets that move along the hollow cone. The separating opening is configured to supply the droplets that move inside the hollow cone to the outlet opening of the mixing chamber. In other words, the separating device has the separating opening, which may be, for example, a circular opening, which may be outwardly surrounded by a baffle. The baffle may be an annular surface designed to catch the droplets of the hollow cone. The separating opening may be an entrance of a tube which may be connected to the output opening of the mixing chamber. The main flow path through the mixing chamber may extend through the separating opening.

A refinement of the invention provides that the air humidifier has a recovery device configured to supply the recovered liquid from the separating device to the atomizing nozzle. In other words, it is provided that the liquid that accumulates from the droplets accumulating in the separating device be supplied by the recovery device to the atomizing nozzle in order that the liquid can be emitted through the atomizing nozzle again. This provides the advantage that the fluid consumption by the air humidifier can be reduced, which makes it possible to reduce the amount of a liquid to be provided by a liquid reservoir. The recovery device may, for example, include a membrane or a condenser for collecting the liquid.

A refinement of the invention provides that the air humidifier has a controller configured to adjust the amount of liquid to be discharged by the atomizing nozzle in order to control the mixing ratio of the gas and the liquid at the outlet opening of the mixing chamber to a predetermined value. In other words, the air humidifier is configured to control the mixing ratio of the gas and the liquid at the outlet opening of the mixing chamber to a predetermined value. For this purpose, the air humidifier has the controller that selects the amount of liquid released by the atomizing nozzle during a certain time window such that the mixture emitted at the outlet opening of the mixing chamber has the predetermined mixing ratio. To provide a mixing ratio of the introduced gas and of the discharged gas to the controller, sensor data may be received by sensors of an installation location in which the air humidifier is disposed.

A second aspect of the invention relates to a method for operating an air humidifier having a mixing chamber in which is disposed an atomizing nozzle. Gas is conveyed along a main flow path through the mixing chamber. A liquid is emitted by the atomizing nozzle as a spray mist. The gas is mixed with the spray mist in the mixing chamber and discharged at an outlet opening of the mixing chamber. It is provided that a swirl be imparted to droplets of the spray mist by a swirl device of the atomizing nozzle. Due to the swirl of the droplets, the spray mist is emitted by the atomizing nozzle as a straight circular spray cone opening along the main flow path with a cone angle. Droplets of the circular spray cone that move from the atomizing nozzle along a hollow cone having a predetermined interior angle are caught by a separating device of the mixing chamber. A liquid recovered by catching the droplets is discharged by the separating device at a separation outlet of the separating device. Droplets that move inside the hollow cone are supplied by the separating device to the outlet opening of the mixing chamber. Other features and their advantages can be inferred from the description of the first aspect of the invention.

A third aspect of the invention relates to a system including air humidifiers and a fuel cell stack. The fuel cell stack includes a plurality of fuel cells as segments. The system has a cathode air supplying device configured to introduce cathode air to be mixed with water into the air humidifiers. It is provided for the air humidifiers to be connected at their respective outlet openings, in particular outlet openings of respective mixing chambers of the air humidifiers, to respective ones of the fuel cells. In other words, it is provided that each of the fuel cell stack segments have a separate air humidifier associated therewith. Thus, the mixtures emitted by the air humidifiers are each supplied to only one of the fuel cell segments. This provides the advantage of enabling individual control of the air humidifiers in order to individually control the air humidity in the fuel cells.

A refinement of the invention provides that the system be configured as an aviation prime mover. In other words, the system is designed to propel an aircraft.

Other features and their advantages can be inferred from the descriptions of the first and second aspects of the invention.

### BRIEF DESCRIPTION OF THE DRAWINGS

Other features of the invention will become apparent from the claims, the figures, and the detailed description. The features and feature combinations mentioned above in the description as well as the features and feature combinations mentioned below in the description of the figures and/or shown in isolation in the figures are usable not only in the respectively specified combination, but also in other combinations without departing from the scope of the invention. Thus, embodiments of the invention that are not explicitly shown and described in the figures, but derive from and can be produced by separate feature combinations from the explained embodiments, are also considered to be included and disclosed herein. Hence, embodiments and combinations of features that do not have all of the features of an originally formulated independent claim should also be considered as being disclosed. Moreover, embodiments and combinations of features that go beyond or differ from the combinations of features set forth in the back-references of the claims should be regarded as having been disclosed, in particular by the embodiments set forth above. In the drawing,

FIG. 1 is a schematic view of an air humidifier according to the invention;

FIG. 2 is a schematic view of a possible embodiment of the inventive system, including a plurality of air humidifiers; and

FIG. 3 is another schematic view of the system depicted in FIG. 2.

### DETAILED DESCRIPTION

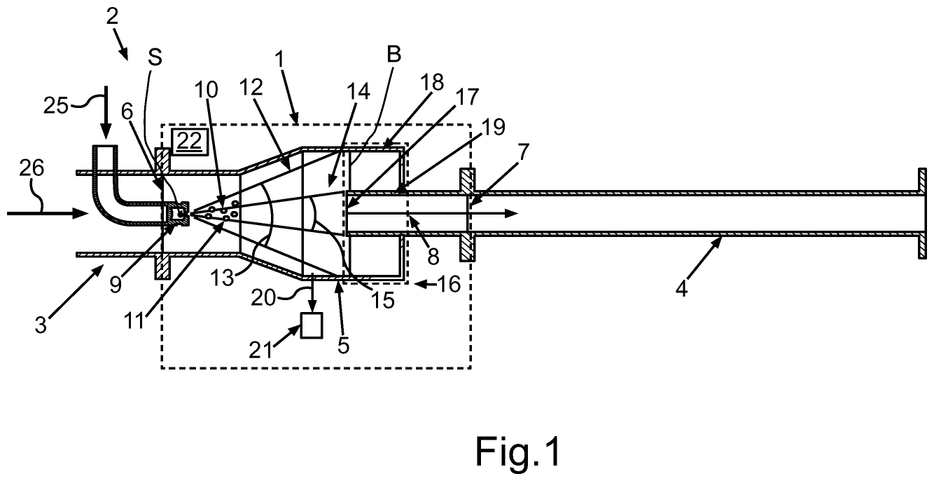

FIG. 1 shows in schematic form an inventive air humidifier 1 disposed in a system 2. Air humidifier 1 may be designed to mix a liquid 25 with a gas 26. Liquid 25 may be, for example, water which is intended to be mixed with air to ensure a predetermined humidity of gas 26. Air humidifier 1 may be integrated into system 2 via an inlet tube 3 and an outlet tube 4. Air humidifier 1 may have a mixing chamber 5, which may be configured to allow mixing of liquid 25 with gas 26. Mixing chamber 5 may have an inlet opening 6 to which inlet tube 3 may be connected. Mixing chamber 5 may have an outlet opening 7 to which outlet tube 4 of system 2 may be connected. Gas 26 to be mixed may be supplied through inlet tube 3, introduced through inlet opening 6 into mixing chamber 5, and discharged at outlet opening 7 of mixing chamber 5. In this process, gas 26 may be guided along a main flow path 8. Main flow path 8 may be produced, for example, by providing a positive pressure at inlet tube 3. In order to enable mixing of the introduced gas 26 in mixing chamber 5, an atomizing nozzle 9 may be disposed in mixing chamber 5. Atomizing nozzle 9 may be configured to emit a spray mist 10, which may contain droplets 11 of liquid 25 to be mixed. Liquid 25 may be supplied, for example, via a supply pipe of atomizing nozzle 9. Atomizing nozzle 9 is in particular a single-fluid atomizing nozzle. Atomizing nozzle 9 may have a swirl device S (shown solely schematically in FIG. 1), which may be configured to impart a swirl to the droplets 11 to be emitted, so that the released spray mist 10 has the shape of a circular spray cone. Circular spray cone 12 may be formed by the droplets 11 moving in a spiral direction as a result of an imparted swirl and by the gas 26 moving along main flow path 8. In this process, droplets 11 with a larger mass move along an edge of circular spray cone 12, while droplets 11 with a smaller mass may move closer to the center of circular spray cone 12. Spray circle cone 12 may have a certain cone angle 13 depending on the velocity of the gas 26 flowing along main flow path 8 and the swirl imparted on droplets 11. Atomizing nozzle 9 may be oriented along main flow path 8 toward outlet opening 7. Outlet opening 7 may have a circular shape with a predetermined radius. Cone angle 13 of circular spray cone 12 may have a size that may cause only a portion of droplets 11 to be supplied to outlet opening 7. Droplets 11 having a larger mass may be guided into an area outside the outlet opening 7. As a result, circular spray cone 12 is spit into an inner cone and a hollow cone 14. The inner cone may have an interior angle 15. Droplets 11 moving within the inner cone are supplied to outlet opening 7, while droplets 11 moving along hollow cone 14 are not supplied to output opening 7. To be able to catch the droplets 11 of hollow cone 14, air humidifier 1 may have a separating device 16, which may be configured to catch the droplets 11 of the hollow cone and to supply the inner droplets 11 to outlet opening 7. For this purpose, separating device 16 may have a separating opening 17 to catch the droplets 11 that flow within interior angle 15. Separating device 16 may be configured, for example, as a coaxial tube, where an outer tube 18, which may be provided for receiving outer droplets 11 of hollow cone 14, may have an inner tube 19 therein, which is designed to supply the droplets 11 moving within interior angle 15 to outlet opening 7. Separating device 16 may have a separation outlet 20, which may be configured to discharge the liquid 25 that is collected in separating device 16 by catching droplets 11. In an alternative embodiment of air humidifier 1, it may be provided that separation device 16 has a baffle B (shown solely schematically in FIG. 1) capable of catching the outer droplets 11. The baffle may be configured to circumferentially surround separating opening 17. Air humidifier 1 may have a recovery device 21, which may be configured to supply the recovered liquid 25 from separating device 16 to atomizing nozzle 9. Recovery device 21 may include, for example, a condenser or a pump. The provision of recovery device 21 makes it possible, for example, to reduce an amount of liquid to be stored in a reservoir. Air humidifier 1 may have a controller 22, which may be configured to determine the amount of liquid to be discharged by atomizing nozzle 9 in order to control the mixing ratio of gas 26 and liquid 25 at outlet opening 7 of mixing chamber 5 to a predetermined value. Controller 22 may include, for example, a microprocessor or a microcontroller and may be configured to detect the mixing ratio of gas 26 and liquid 25 and to control the atomizing nozzle 9 as a function of a predetermined mixing ratio of gas 26 and liquid 25 so as to adjust the amount of liquid to be discharged by atomizing nozzle 9 in such a way that the predetermined mixing ratio of gas 26 and liquid 25 can be obtained.

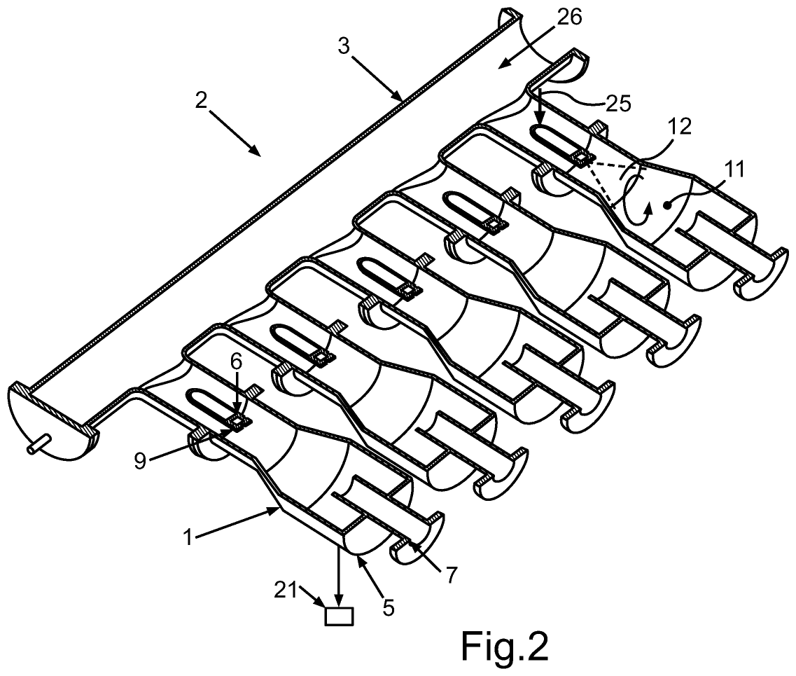

FIG. 2 shows in schematic form a possible embodiment of system 2, which includes a plurality of air humidifiers 1. For system 2 to operate, it may be necessary that there be a predetermined mixing ratio between liquid 25 and gas 26. It may be provided, for example, that the gas 26 to be humidified may be supplied by a pump or a compressor. Gas 26 may, for example, be air. Gas 26 may be supplied at a predetermined pressure, allowing it to flow along inlet tube 3 and through mixing chamber 5 of air humidifier 1 along main flow path 8. It may be provided that gas 26 be guided through several of the air humidifiers 1. Air humidifiers 1 may be configured to mix gas 26 with liquid 25 to a respective mixing ratio. The mixing ratio to be obtained may differ between the individual air humidifiers 1.

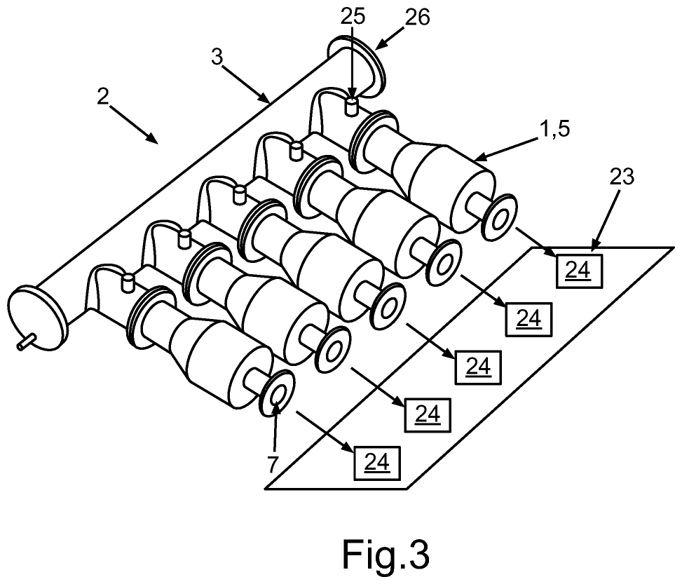

FIG. 3 shows the system 2 of FIG. 2 in another schematic view. System 2 may be designed, for example, to humidify air for operating a fuel cell stack 23, which may include a plurality of fuel cells 24. Gas 26 may be, for example, air, which may be supplied as cathode air into fuel cells 24 to humidify a separating membrane of a cathode. In order to enable operation of the individual fuel cells 24, it may be necessary to humidify the membranes of fuel cells 24 with fine droplets 11. The membranes may in particular be polymer electrolyte membranes. To allow the membrane to be evenly humidified, it may be necessary that the droplets 11 supplied into the air by air humidifier 1 not exceed a certain size. This may allow fuel cells 24 to be cooled by evaporation and may prevent accumulation of water in fuel cells 24, in particular in a flow profile of fuel cells 24. A current level of humidity of the respective membranes may differ between the individual fuel cells 24. For this reason, it may be advantageous if each of the fuel cells 24 has a respective air humidifier 1 associated therewith. This provides the advantage of allowing the air humidity to be controlled individually for the respective fuel cells 24.

System 2 may be configured, for example, as an aviation prime mover and may be designed to humidify the cathode air for fuel cells 24 for driving an electric motor of an aircraft. Another possible embodiment of system 2 may be designed, for example, to humidify a combustion chamber of a turbine engine to enable a uniform temperature distribution or to minimize the formation of unwanted gas components in the combustion chamber.

Passive humidifiers are known from the automotive field. These humidifiers do not allow for targeted control of the relative humidity of the cathode air, are heavy and voluminous, and do not contribute to the cooling of a cell stack. Active humidification systems have already been investigated, using two-fluid atomizing nozzles. In order to achieve the atomization effect, these nozzles require an additional compressed air level significantly above that of the cathode air itself. In order to generate this compressed air level, a high degree of complexity is required, especially at low ambient air pressure, such as prevails in aircraft at cruising altitude.

The polymer electrolyte membrane (PEM) of each individual fuel cell segment must be humidified individually, without causing water accumulations in the flow field. At the outlet of a fuel cell stack, the relative humidity must be adjusted to 100%. The humidification must be suitable for an aviation prime mover. In contrast to applications in the automotive field, in the field of aviation, the ambient air contains less water and the amounts of air to be humidified are larger.

Provision is made to actively humidify each fuel cell stack segment, using one single-fluid atomizing nozzle for each segment, each nozzle introducing an individually defined amount of water into the cathode air of the stack segment. The atomizing nozzle creates a swirl in the circular spray cone, causing the larger water droplets to move outward. These droplets are separated by a kind of baffle or a stepped tube, and only the inner portion of the circular spray cone with the fine water droplets is passed on into the stack segment. The separated water may be recirculated in order to be discharged by the atomizing nozzle again.

The expenditure of energy, the weight, and the space required for the water pump of a single-fluid nozzle are significantly less than for an additional compressor stage for a two-fluid nozzle. The not-quite-so-fine atomization of the single-fluid nozzle is compensated for by separating the coarser portion of the drop spectrum. The fine water droplets contribute to the cooling of the stack by being evaporated therein. The passive humidifiers from the automotive field are too large and too heavy for an aviation prime mover and cannot ensure the required relative humidity of 100% at the stack outlet under the boundary conditions.

### LIST OF REFERENCE NUMERALS

1 air humidifier
2 system
3 inlet tube
4 outlet tube
5 mixing chamber
6 inlet opening
7 outlet opening
8 main flow path
9 atomizing nozzle
10 spray mist
11 droplets
12 circular spray cone
13 cone angle
14 hollow cone
15 interior angle
16 separating device
17 separating opening
18 inner tube
19 outer tube
20 separation outlet
21 recovery device
22 controller
23 fuel cell stack
24 fuel cell
25 liquid
26 gas

What is claimed is:

1-8. (canceled)

9. An air humidifier comprising:
an atomizing nozzle configured to discharge a liquid as a spray mist;
a mixing chamber, the atomizing nozzle disposed in the mixing chamber, the mixing chamber being configured such that a gas conveyed along a main flow path through the mixing chamber is mixed with the spray mist and discharged at an outlet opening of the mixing chamber,
the atomizing nozzle having a swirl imparter configured to impart a swirl to droplets of the spray mist in order to emit the spray mist as a straight circular spray cone opening along the main flow path with a cone angle,
the mixing chamber having a separator configured to catch droplets of the circular spray cone that move from the atomizing nozzle along a hollow cone having a predetermined interior angle, to discharge liquid recovered by catching the droplets at a separation outlet of the separator, and to supply droplets that move inside the hollow cone to the outlet opening of the mixing chamber.

10. The air humidifier as recited in claim 9 wherein the separator has a coaxial tube, an outer tube of the coaxial tube being configured to catch the droplets that move along the hollow cone, and an inner tube of the coaxial tube being configured to supply the droplets that move inside the hollow cone to the outlet opening of the mixing chamber.

11. The air humidifier as recited in claim 9 wherein the separator has a separating opening circumferentially surrounded by a baffle, the baffle being configured to catch the droplets that move along the hollow cone, and the separating opening being configured to supply the droplets that move inside the hollow cone to the outlet opening of the mixing chamber.

12. The air humidifier as recited in claim 9 wherein the air humidifier has a recovery device configured to supply the recovered liquid from the separator to the atomizing nozzle.

13. The air humidifier as recited in claim 9 further comprising a controller configured to adjust the amount of liquid to be discharged by the atomizing nozzle in order to control the mixing ratio of the gas and the liquid at the outlet opening of the mixing chamber to a predetermined value.

14. A method for operating an air humidifier having a mixing chamber, an atomizing nozzle disposed in the mixing chamber, the method comprising:
conveying gas along a main flow path through the mixing chamber;
discharging a liquid by the atomizing nozzle as a spray mist; and
mixing the gas with the spray mist in the mixing chamber and discharging the gas mixed with the spray mist at an outlet opening of the mixing chamber;
a swirl being imparted to droplets of the spray mist by a swirl device of the atomizing nozzle, and due to the swirl of the droplets, the spray mist is emitted by the atomizing nozzle as a straight circular spray cone opening along the main flow path with a cone angle, droplets of the circular spray cone that move from the atomizing nozzle along a hollow cone having a predetermined interior angle being caught by a separator of the mixing chamber, a liquid recovered by catching the droplets being discharged by the separator at a separation outlet of the separating device, and droplets that move inside the hollow cone being supplied by the separator to the outlet opening of the mixing chamber.

15. A system comprising:
air humidifiers, each as recited in claim 9;
a fuel cell stack including fuel cells;
a cathode air supplying device configured to introduce cathode air to be mixed with water into the air humidifiers, the air humidifiers being connected at respective outlet openings to respective ones of the fuel cells.

16. The system as recited in claim 15 wherein the system is configured as an aviation prime mover.
